(19) United States
(12) Patent Application Publication
(10) Pub. No.: US 2008/0034423 A1
(43) Pub. Date: Feb. 7, 2008

(54) Method Of Managing A Multi-Application Smart Card

(75) Inventors: Jean-Francois Durix, Trets (FR); Francois Millet, La Ciotat (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 11/630,399

(22) PCT Filed: Jun. 9, 2005
(86) PCT No.: PCT/EP05/52684

§ 371 Date: Dec. 22, 2006

(30) Foreign Application Priority Data
Jun. 23, 2004 (FR) 0406838

(51) Int. Cl. H04L 9/32

(52) U.S. Cl. 726/20

(57) ABSTRACT

A method of managing a multi-application electronic device, such as a multi-application smart card, of the type having an operating system which is designed to support a plurality of applications. Each of the applications belongs to an application provider having a unique security domain which is initially installed on the card. Upon receipt of a command for an application to be loaded onto the device, the operating system verifies that the application is associated with a security domain corresponding to the security domain of the application provider. In the event of successful verification, the operating system authorizes the loading and installation thereof on the card, connecting the same automatically to the security domain.

The present invention relates, in general terms, to the domain of so-called “intelligent” chip cards (Smartcards), insofar as said cards constitute an electronic data medium, in the form of a small-format card which is also equipped with processing capabilities implemented by a microprocessor and its operating system and their environment (different memory types, input/output).

The invention relates more specifically to multi-application chip cards, comprising a plurality of applications installed on the card itself, thus allowing the execution of high-level applications, intended for various uses.

In this context, the card issuer is the main authority for the purpose of managing the contents of the card. As such, it alone is capable of executing certain application management functions, such as loading an application onto the card, installing the application or even deleting the application from the card. The applications installed on the card are usually developed by the card issuer in a secure environment.

However, the fact that only the card issuer is authorised to control the deployment of applications on the card has disadvantages in terms of flexibility and, in particular, of adaptability to various user needs.

Furthermore, it is increasingly desirable to convert chip cards into open environments for executing programs, allowing dynamic loading of applications. It is also desirable to increase the flexibility and upgradeability of card application management. This leads to a situation in which card applications are no longer developed under the control of the card issuer. Instead they are developed and offered by third-party application providers, who own their applications. These proprietary applications can be dynamically loaded onto the card after being issued by the issuer, for example over any given network.

It is therefore necessary in this case, for the application provider to establish contractual agreements, both commercial and technical, between itself and the card issuer, with a view to defining the conditions of use of its applications which may be installed on the card. This contract between the application provider and the card issuer is materialised specifically by the installation on the card, once it has been initialised, of a security domain associated with the application provider, which essentially means that the card issuer grants usage rights to the application provider.

Thus, any application subsequently loaded onto the card must be associated with a security domain, which is specified by the card issuer when the application is downloaded.

The various security domains are implemented on the card by means of specific applications, one for each security domain, making it possible to implement and ensure fulfilment of the operating mode contractually defined between the card issuer and each application provider. In particular, these specific security domain applications are responsible for authenticating and verifying the applications of the associated application provider during the download process. They also provide common services for all the applications of a given application provider, without which the application cannot be executed on the card.

The security domain of an application provider is therefore the application, created on the card during its initialisation, which guarantees that the application provider applications installed on the card after being issued will work properly.

Thus, during the phase of loading and installing an application on a multi-application card, it is essential to ensure that the application in question is properly associated with the security domain of the card associated with the relevant application provider. In this way, the application provider, which owns the application in question, has the assurance that the rules for operation and use of its application on the card, contractually established with the card issuer, will be honoured.

And yet, until now, it is the card issuer who specifies the security domain associated with the application while it is being downloaded. There are no specific mechanisms implemented on the card that make it possible to strengthen the contractual obligations agreed between the application provider and the card issuer, so that the application provider can have the assurance that the use of its application on the card will conform to that which has been predefined, in other words that the application loaded and installed on the card is properly associated with its security domain.

Furthermore, the life-cycle management for these applications by an application provider is placed under the authority of the card issuer, in accordance with the operating conditions initially stipulated by contract between the issuer and the provider. Thus, the card issuer is authorised to manipulate an application developed by an application provider and already installed on the card, in particular in order to lock it so as to restrict access or even to delete it from the card, after the agreement between the provider and the issuer has expired, for example.

There again, no specific mechanisms are provided on the card to ensure that the application provider's authorisation has been granted to make it possible to delete or lock one or more of its applications on the card. This authorisation is important insofar as an application on the card remains the responsibility of the provider of this application and all actions carried out on same should normally be performed with the consent of the provider who owns the application.

Also, in the context of a multi-application card, when an application is loaded, it most often imports other applications or APIs (Application Programming Interface) which are already installed on the card and which are required for its implementation on the card. Indeed, in order to work, the application needs to use program libraries which group together sets of functions and, in the context of a multi-application card, the loaded application must indicate these libraries so that the card operating system can edit the links.

And yet, on a multi-application chip card forming an open platform, there is no mechanism that allows an application provider to control the use of an API or an application developed by another provider. Thus, an application provider may use any API belonging to any other application provider, to the detriment of the property rights of the latter.

Within this context, the present invention, which is founded on these different assessments, has the objective of providing specific mechanisms, ensuring the authorisation of an application provider prior to any action carried out on an application supplied by this provider on a multi-application card, in such a way that the application provider can control access and use of its applications on the card and thereby ensure in particular that its property rights are respected.

The present invention therefore aims to reinforce the terms of the contractual links which underlie the cooperation between card the issuer and the application provider.

With this objective in mind, the invention therefore aims to provide a method of managing a multi-application electronic device, comprising an operating system designed to support a plurality of applications, each application belonging to an application provider having access to its own unique security domain initially installed on the device, said method being characterised in that, upon receiving a command to load an application onto the device, said operating system verifies that said application is associated with a security domain corresponding to the security domain of the provider of said application and, once successfully verified, authorises it to be loaded and installed on the device while automatically associating it with said security domain.

According to a first embodiment of the invention, the verification stage consists of searching among the security domains installed on the device for the one in which the identifier of the application provider corresponds to the identifier of the application to be loaded.

According to a second embodiment of the invention, the loading command received comprises, in addition to the application to be loaded, the application provider identifier corresponding to the security domain with which it is to be associated, the verification consisting of ensuring that said identifier corresponds to the identifier of said application.

According to another characteristic of the invention, a step of controlling access to at least one application installed on the device performed by the security domain of the application provider with which said application is associated, is implemented by the device's operating system, for authorising an action on the said application.

Preferably, the access control consists of requiring the presentation of an electronic signature and verifying said signature.

The action on the application can involve removing said application from the device.

The action on the application can also involve locking the use of said application.

The action on the application can further involve at least partial use of said application by a new application loaded onto the device and belonging to another application provider.

According to an alternative embodiment, the applications consist of Application Programming Interfaces (API).

The invention also relates to a multi-application chip card, characterised in that it comprises the means for implementing the method as described above.

Preferably, the card is of the Java Card type.

Further characteristics and advantages of the present invention will become clearer from reading the following description provided as an illustrative, non-limiting example and made in reference to the following drawings, in which:

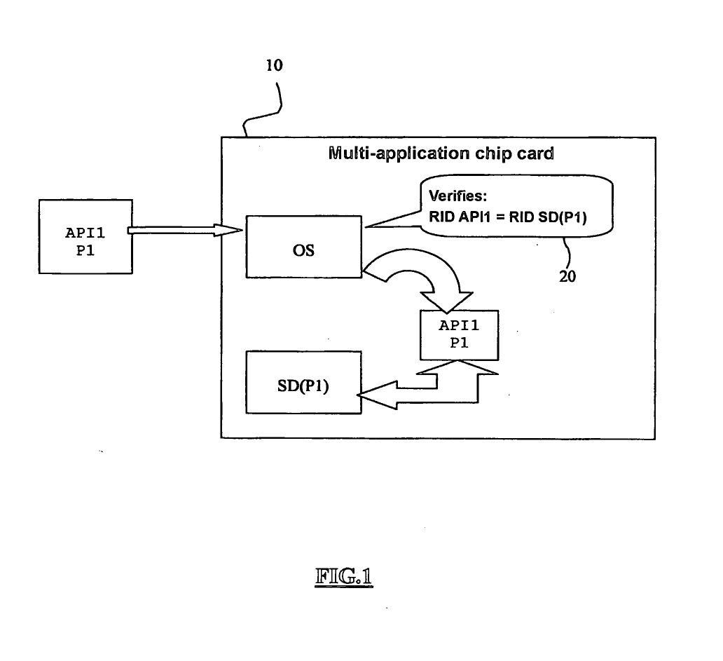

FIG. 1 shows a schematic view of the card content management method according to the invention, during the phase of loading and installing an application on the card, and

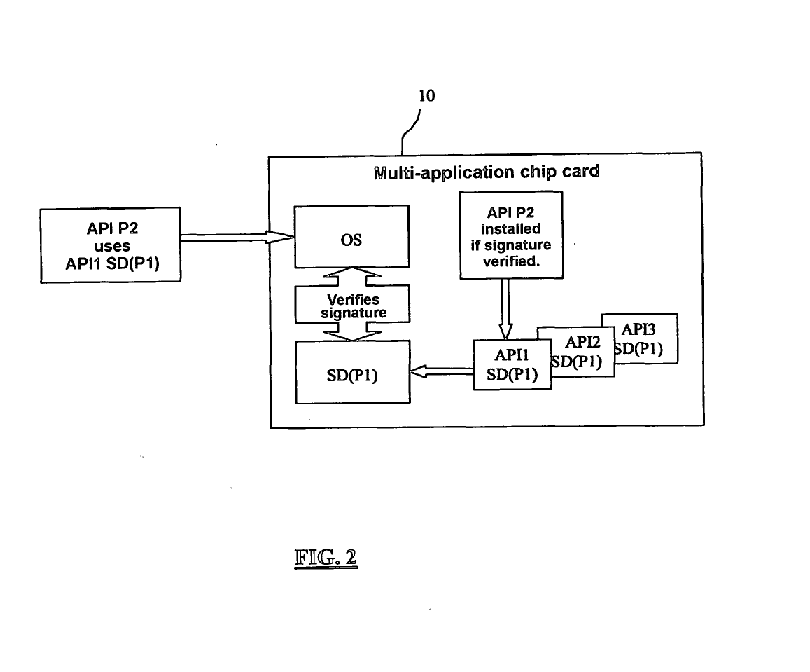

FIG. 2 shows an example of a card content management method according to the invention, in the case of importing an application already installed on the card.

The multi-application chip card is based, in a preferred embodiment of the invention, on the Java Card (registered trademark) operating system. According to this standard, multi-application card applications are programmed by application providers in the form of applets. The Java Card standard introduces means for applets to interact directly. In this way, an applet can use modules from another applet through a sharing interface.

FIG. 1 therefore shows, in this context, a method of managing a multi-application card 10 equipped with an operating system OS, during the phase of loading an application on the card. More specifically, according to the example, the application loaded onto the card consists of an application programming interface API1 supplied by an application provider P1. As has already been explained, a security domain SD(P1) for this application provider has been implemented on the card and groups together all the applications and application programming interfaces belonging to this particular application provider.

The programming interfaces form a set of Java libraries, which group together predefined objects and methods, which can be used in a modular fashion and allow the implementation of Java applications.

Thus, the aim is to ensure that the programming interface API1 supplied by the application provider P1, is associated with the correct security domain, namely the P1 security domain, SD(P1).

In order to do this, a specific application identifier which must be loaded onto the chip card and a specific identifier for the application provider will be used, allowing the identification of the associated security domain. Indeed, when a security domain is created on the card, it is associated with an application provider and therefore contains the identifier of the application provider.

In the context of multi-application chip cards, all applications are identified by a unique identifier known as AID (Application Identifier), defined by the ISO/IEC 7816-5 standard. This AID is coded in 16 bytes, the first 5 of which represent, according to the standard, the RID (Registered application provider Identifier) making it possible to identify the application provider.

Thanks to these identifiers, when a command to load the programming interface API1 onto the card is received, the operating system OS of the card automatically verifies, as shown by reference 20 in FIG. 1, that the security domain SD(P1) chosen by the application actually has the same RID as the application in question.

According to a first embodiment of the invention, the operating system OS searches, among a list which it has at its disposal containing all the security domains installed on the card, for a security domain in which the RID matches the AID of the programming interface API1 to be loaded. The security domain SD(P1) is then found and the operating system OS authorises the loading and installation of the programming interface API1 on the card while automatically associating it with the relevant security domain SD(P1).

According to another embodiment of the invention, the RID of the application provider corresponding to the security domain to be associated with the programming interface API1 is transmitted at the same time as the latter. Thus, verification 20 involves simply verifying that this RID matches the AID of the application, in order to ensure that the loaded application API1 is actually associated with the security domain SD(P1) associated with the application provider P1.

If the verification described in 20 fails, the loading of the programming interface API1 is rejected by the card.

In this way, thanks to the mechanisms described above, it is possible automatically to ensure, by means of the card operating system, that the API1 interface supplied by the application provider P1 is installed on the card in the correct security domain SD(P1).

Another aim of the invention also involves ensuring, by specific means provided on the card, that proper authorisation has been acquired from the relevant application provider when the operating system OS wants to access an application by said provider already installed on the card, with a view to performing any action on this application.

In particular, this action can consist of deleting the application or locking the use of this application on the card.

A privilege is then defined for the security domains associated with the application providers that want to control access to their applications on the card and that their authorisation be formally requested prior to any deletion or locking of their applications installed on the card.

To this effect, specific data can characterise such a security domain and can then be used by the operating system of the card as a criterion for determining whether access authorisation exists, when it wants to access an application associated with this security domain, in order to delete it for example.

Thus, when it sees this privilege, the operating system will have to call a particular interface in this security domain for the latter to authorise access to the application affected by the deletion. Specifically, an electronic signature is added to the command issued by the operating system and this signature must be previously verified by the associated security domain.

This access control for an application on the card, imposed by the security domain of the application provider with which the application is associated, is also implemented when the action on the application consists of at least partial use of said application by a new application loaded onto the card belonging to another application provider.

Indeed, when a new application or programming interface is loaded, in order to be able to work, it can be made to use other programming interfaces already installed on the card and belonging to the security domain of another application provider. In this case, it is important, with a view to preserving the property rights of this application provider, to allow the latter to control the use of its applications or APIs on the card.

FIG. 2 shows an example of this card content management method, in the case of importing an application already installed on the card by an application belonging to another application provider.

A security domain SD(P1) associated with the application provider P1 is installed on the multi-application chip card 10. The application programming interfaces API1, API2, and API3 belonging to this provider P1 have already been loaded and installed on the card according to the management method explained previously in reference to FIG. 1, therefore being associated with the security domain SD(P1). A programming interface API P2, supplied by an application provider P2 other than P1, is loaded onto the card. In the example of FIG. 2, this API P2 wants to use the API1 from application provider P1 which is already installed on the card. In other words, it must import the resources of this API1 in order to be loaded onto the card.

And yet, the programming interface API1 which must be imported by the programming interface API P2 being loaded belongs to a security domain SD(P1) which wants to control its access. Indeed, a privilege is defined by the security domain SD(P1), which informs the operating system of the card that this security domain requires the presentation of a signature in order to authorise a connection with its associated programming interface API1.

The card operating system OS, on seeing this privilege, will call up an interface in the security domain SD(P1) to obtain the authorisation of the latter prior to authorising link editing between the programming interfaces API P2 and API1.

For this purpose, the signature, which is normally supplied by the application provider P1 to authorise connection to its programming interface API1, must be included when loading the programming interface API P2 onto the card. In the case of API P2 having to import resources from other applications or programming interfaces belonging to P1, it would be necessary to include a signature for every application or programming interface imported.

The operating system then calls up the signature verification and the security domain SD(P1) verifies the signature, in order to authorise the use of its programming interface API1 resources. If the signature is successfully verified, API P2 is installed on the card. In case of failure, the loading of API P2 is not authorised, as this means that this application is trying to use resources which it is not authorised to access.

Thus, when an application is being loaded, the operating system identifies the list of applications already installed on the card which the application being loaded wants to use and determines the security domains associated with these applications. If these security domains include security domains which require access control to authorise the use of their applications, then the operating system performs this access control.

Although the entire preceding description was made in relation to a multi-application chip card, it is understood that the characteristics of the present invention can be applied more generally to any multi-application electronic device comprising an operating system designed for supporting a plurality of applications. In particular, the present invention can be applied to content management for a PC-type computer, the issuer in this case referring to the owner of the PC.

1. A method of managing a multi-application electronic device, having an operating system designed to support a plurality of applications, each application belonging to an application provider having a proprietary security domain initially installed on the device,
said method including the step wherein, when the device receives a command to load an application comprising an identifier representing the application provider, said operating system verifies that said identifier identifies a security domain corresponding to the security domain of the provider of said application and, if the verification is successful, authorises loading and installation of the application on the device while automatically associating the application with said security domain.

2. The method according to claim 1, wherein the verification stage involves searching among the security domains installed on the device for the one in which the identifier of the application provider corresponds to the identifier of the application to be loaded.

3. The method according to claim 1, wherein the loading command comprises, in addition to the application to be loaded, the application provider identifier corresponding to the security domain with which the application is to be associated, and wherein the verification step ensures that said identifier corresponds to the identifier of the said application.

4. The method according to claim 1, wherein said operating system implements a step of controlling access to at least one application installed on the device that is performed by the security domain of the application provider with which said application is associated, for authorising an action on said application.

5. The method according to claim 4, wherein the access control comprises requiring the presentation of an electronic signature and verifying said signature.

6. The method according to claim 4, wherein the action on the application involves removing said application from the device.

7. The method according to claim 4, wherein the action on the application involves locking the use of said application.

8. The method according to claim 4, wherein the action on the application involves at least partial use of said application by a new application loaded onto the device and belonging to another application provider.

9. The method according to claim 1, wherein the applications comprise application programming interfaces.

10. A multi-application chip card, comprising an operating system designed to support a plurality of applications, each application belonging to an application provider having a proprietary security domain initially installed on the device, said operating system being responsive to a command to load an application comprising an identifier representing the application provider, to verify that said identifier identifies a security domain corresponding to the security domain of the provider of said application and, if the verification is successful, to authorize loading and installation of the application on the device while automatically associating the application with said security domain.

11. A chip card according to claim 10, wherein said card is a Java Card.

12. The method according to claim 2, wherein said operating system implements a step of controlling access to at least one application installed on the device that is performed by the security domain of the application provider with which said application is associated, for authorising an action on said application.

13. The method according to claim 3, wherein said operating system implements a step of controlling access to at least one application installed on the device that is performed by the security domain of the application provider with which said application is associated, for authorising an action on said application.

14. The method according to claim 5, wherein the action on the application involves removing said application from the device.

15. The method according to claim 5, wherein the action on the application involves locking the use of said application.

16. The method according to claim 5, wherein the action on the application involves at least partial use of said application by a new application loaded onto the device and belonging to another application provider.
